(19) United States
(12) Patent Application Publication
(10) Pub. No.: US 2018/0348444 A1
(43) Pub. Date: Dec. 6, 2018

(54) OPTICAL CONNECTOR

(71) Applicants: SUMITOMO ELECTRIC INDUSTRIES, LTD., Osaka (JP); SEI Optifrontier Co., Ltd., Yokohama-shi (JP)

(72) Inventors: Yoshikyo Tamekuni, Osaka (JP); Kazuya Masuda, Osaka (JP); Tomohiko Ueda, Osaka (JP); Yuji Suzuki, Yokohama-shi (JP)

(73) Assignees: SUMITOMO ELECTRIC INDUSTRIES, LTD., Osaka (JP); SEI Optifrontier Co., Ltd., Yokohama-shi (JP)

(21) Appl. No.: 15/991,175

(22) Filed: May 29, 2018

(30) Foreign Application Priority Data
May 30, 2017 (JP) 2017-106820

(51) Int. Cl. G02B 6/38; G02B 6/26; H01R 13/62

(52) U.S. Cl. CPC G02B 6/3825; G02B 6/26; H01R 13/62; G02B 6/3893; G02B 6/3869; G02B 6/3821

(57) ABSTRACT

The optical connector according to one embodiment includes a plurality of optical connector plugs collectively connected to a plurality of adapters in a connection direction, wherein each of the optical connector plugs includes a tubular ferrule which holds an optical fiber, and a diameter of the ferrule is smaller than that of a ferrule defined by the international standard of the optical connector.

### TECHNICAL FIELD

An aspect of the present disclosure relates to an optical connector with a plurality of optical connector plugs to be connected collectively.

### BACKGROUND

Japanese Unexamined Patent Publication No. 2012-242781 describes an optical connector in which a plurality of optical connector plugs are collectively inserted and removed. The optical connector includes three plug units, a housing which covers the periphery of the three plug units, and a support flat plate which supports the three plug units inside the housing. Each of the three plug units includes a lock mechanism (latch mechanism) which engages with an adapter.

### SUMMARY

According to an aspect of the present disclosure, there is provided an optical connector which comprises a plurality of optical connector plugs collectively connected to a plurality of adapters in a connection direction, wherein each of the optical connector plugs comprises a tubular ferrule which holds an optical fiber, and a diameter of the ferrule is smaller than that of a ferrule defined by an international standard of the optical connector.

According to another aspect of the present disclosure, there is provided an optical connector which comprises a plurality of optical connector plugs collectively connected to a plurality of adapters in a connection direction, wherein each of the optical connector plugs comprises a ferrule which holds an optical fiber and a spring which biases the ferrule in the connection direction, and a load of the spring is smaller than that of a spring defined by an international standard of the optical connector.

According to still another aspect of the present disclosure, there is provided an optical connector which comprises a plurality of optical connector plugs collectively connected to a plurality of adapters in a connection direction, wherein each of the optical connector plugs comprises a plate-shaped latch mechanism which engages the optical connector plug with the adapter, and at least one of a width and a thickness of the latch mechanism is smaller than at least one of a width and a thickness of a latch mechanism defined by an international standard of the optical connector.

According to yet another aspect of the present disclosure, there is provided an optical connector which comprises a plurality of optical connector plugs collectively connected to a plurality of adapters in a connection direction, wherein each of the optical connector plugs comprises a ferrule which holds an optical fiber, and a guide pin which positions the optical connector plug and the adapter, and a thickness of the guide pin is thinner than that of a guide pin defined by an international standard of the optical connector.

According to yet another aspect of the present disclosure, there is provided an optical connector which comprises a plurality of optical connector plugs collectively connected to a plurality of adapters in a connection direction, wherein each of the optical connector plugs comprises a ferrule which holds an optical fiber, the ferrule has a guide hole into which a guide pin which positions the optical connector plug and the adapter is inserted, and a diameter of the guide hole is larger than that of a guide hole defined by an international standard of the optical connector.

### BRIEF DESCRIPTION OF THE DRAWINGS

FIG. 1 is a perspective view illustrating an optical connector according to a first embodiment.

FIG. 2 is a side view illustrating the optical connector of FIG. 1.

FIG. 3 is a cross-sectional view illustrating an optical connector plug and a holder of the optical connector of FIG. 1.

FIG. 4 is a front view illustrating the optical connector plug of FIG. 3.

FIG. 5 is a cross-sectional view illustrating an optical connector plug according to a second embodiment.

FIG. 6 is a front view illustrating an adapter of the second embodiment and the optical connector plug of FIG. 5.

FIG. 7 is a cross-sectional view illustrating an optical connector plug and an adapter according to a third embodiment.

FIG. 8 is a front view illustrating the optical connector plug and the adapter of FIG. 7.

FIG. 9 is a front view illustrating an optical connector plug according to a fourth embodiment.

### DESCRIPTION OF THE EMBODIMENTS

### Explanation of Embodiments of Present Disclosure

First, the content of the embodiments of the present disclosure will be described. An optical connector according to one embodiment of the present disclosure is an optical connector including a plurality of optical connector plugs which are collectively connected to a plurality of adapters in a connection direction, each of the optical connector plugs has a tubular ferrule for holding an optical fiber, and a diameter of the ferrule is smaller than that of a ferrule defined by the international standard of the optical connector. In the optical connector according to the embodiment, the diameter of the ferrule is smaller than that of the ferrule defined by the international standard. Therefore, it is easy to insert the ferrules of the plurality of optical connector plugs into respective guide holes. Accordingly, the optical connector plugs can be smoothly inserted.

An optical connector according to another embodiment of the present disclosure is an optical connector having a plurality of optical connector plugs which are collectively connected to a plurality of adapters in a connection direction, each of the optical connector plugs has a ferrule for holding an optical fiber and a spring for biasing the ferrule in the connection direction, and a load of the spring is smaller than that of a spring defined by the international standard of the optical connector. In this optical connector, the load of the spring which biases the ferrule in the connection direction is smaller than that of the spring defined by the international standard. Therefore, since resistance due to the load of the spring applied when connecting can be reduced, the optical connector plug can be smoothly inserted.

An optical connector according to still another embodiment of the present disclosure is an optical connector having a plurality of optical connector plugs which are collectively connected to a plurality of adapters in a connection direction, each of the optical connector plugs has a plate-shaped latch mechanism which engages the optical connector plug with the adapter, and at least one of a width and a thickness of the latch mechanism is smaller than at least one of those of a latch mechanism defined by the international standard of the optical connector. Since at least one of the width and the thickness of the latch mechanism is smaller than those defined by the international standard, the latch mechanism can be easily bent. Therefore, since a force required when the latch mechanism is engaged can be reduced, the optical connector plug can be smoothly inserted.

An optical connector according to yet another embodiment of the present disclosure is an optical connector having a plurality of optical connector plugs which are collectively connected to a plurality of adapters in a connection direction, each of the optical connector plugs includes a ferrule for holding an optical fiber and a guide pin for positioning the optical connector plug and the adapter, and a thickness of the guide pin is thinner than that of a guide pin defined by the international standard of the optical connector. In this optical connector, since the thickness of the guide pin inserted into the guide hole formed on the adapter side is thinner than that defined by the international standard, it is possible to smoothly insert the guide pin into the guide hole. Therefore, the optical connector plug can be smoothly inserted into the adapter.

An optical connector according to yet another embodiment of the present disclosure is an optical connector having a plurality of optical connector plugs which are collectively connected to a plurality of adapters in a connection direction, each of the optical connector plugs has a ferrule for holding an optical fiber, the ferrule has a guide hole into which a guide pin for positioning the optical connector plug and the adapter is inserted, and a diameter of the guide hole is larger than that of a guide hole defined by the international standard of the optical connector. In this optical connector, since the diameter of the guide hole the guide pin provided on the adapter side is inserted is larger than the diameter defined by the international standard, the guide pin is smoothly inserted into the guide hole. Therefore, it is possible to smoothly insert the optical connector plug into the adapter.

### Details of Embodiment of Present Disclosure

A specific example of the optical connector according to the embodiment of the present disclosure will be described with reference to the drawings. The present disclosure is not limited to the following illustrative examples but is meant to be indicated by the scope of the claims and includes all modifications within the scope equivalent to the claims. In the description of the drawings, the same or corresponding elements are designated by the same reference numerals, and redundant explanation will be appropriately omitted.

In the present specification, the “international standard of optical connectors” includes IEC 61754-20 (Fibre optic connector interfaces—Part 20: Type LC connector family) which is the standard of LC connectors, IEC 61754-4 (Fibre optic interconnecting devices and passive components—Fibre optic connector interfaces-Part 4: Type SC connector family) which is the SC connector standard, and IEC 61754-7 (Fibre optic interconnecting devices and passive components—Fibre optic connector interfaces—Part 7-1: Type MPO connector family-One fibre row) which is the MPO connector standard.

### First Embodiment

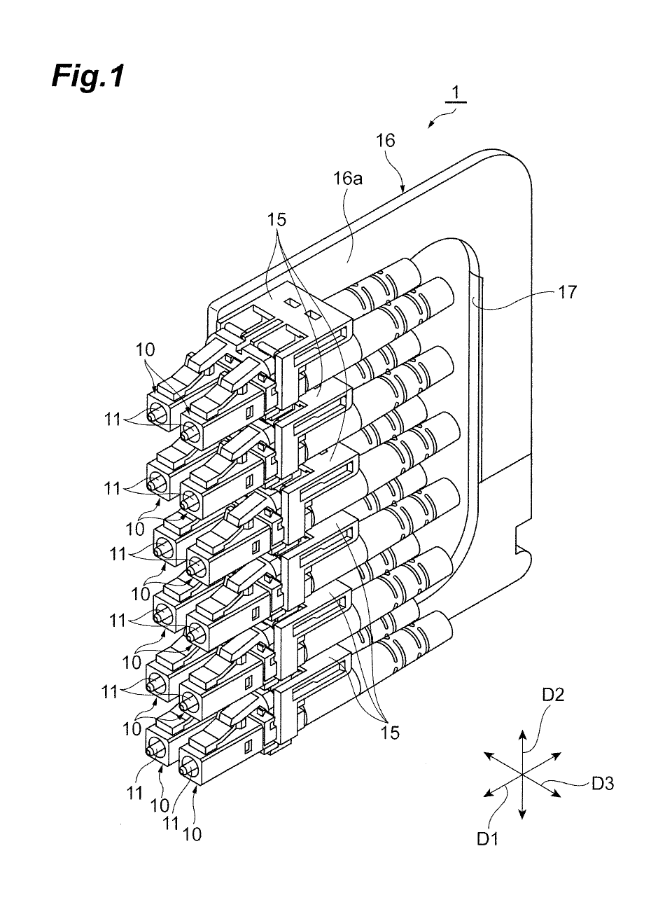

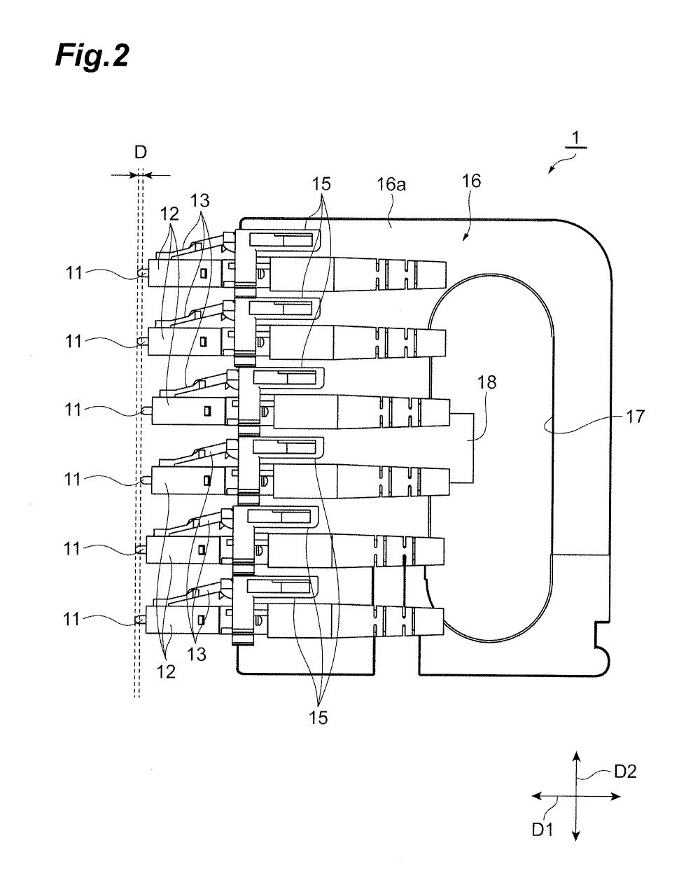

FIG. 1 is a perspective view illustrating an optical connector 1 according to a first embodiment. FIG. 2 is a side view of the optical connector 1. The optical connector 1 is, for example, an optical connector for inspection included in an inspection apparatus which inspects optical communication between a plurality of data centers. An optical wiring rack with a plurality of optical fibers fused is provided at a rack of the data center. The optical communication is inspected by connecting the optical connector 1 to a plurality of adapters disposed on the optical wiring rack.

Recently, as data communication amounts have increased, a multi-core structure of an optical wiring rack has advanced, and the number of adapters has also increased. For example, the number of adapters provided in one optical wiring rack is 288. Since the optical connector 1 is collectively inserted into and removed from a plurality of adapters, even when the number of adapters is large, it is possible to reduce a time taken for insertion and removal.

The optical connector 1 includes twelve optical connector plugs 10 connected to each adapter, a holder 15 which holds the optical connector plugs 10, and a support member 16 to which the holder 15 is fixed. The optical connector 1 is connected to the adapter in a direction D1 which is a connection direction. The optical connector plugs 10 and the adapters are arranged in a direction D2 intersecting the direction D1. For example, the direction D1 is a direction in which the optical connector plugs 10 protrude from the holder 15, and the direction D2 is a direction orthogonal to the direction D1.

Further, the plurality of optical connector plugs 10 are arranged in the direction D2 and are arranged in a direction D3 intersecting the direction D1 and the direction D2. As a specific example, six optical connector plugs 10 are arranged in the direction D2 and two optical connector plugs 10 are arranged in the direction D3. The direction D3 is a direction intersecting a plane extending in the directions D1 and D2 and is, for example, orthogonal to the plane extending in the directions D1 and D2.

Each of the optical connector plugs 10 is an LC connector. Each of the optical connector plugs 10 includes a ferrule 11 which holds an optical fiber, a front housing 12 which accommodates the ferrule 11, and a latch mechanism 13 which engages the optical connector plug 10 with the adapter. In the following description, a side in a direction in which the adapter is provided with respect to the ferrule 11 may be referred to as a front, and a side in an opposite direction thereto may be referred to as a rear.

For example, the ferrules 11 extending from some of the plurality of optical connector plugs 10 are located closer to the adapter side than the ferrules 11 extending from the remaining optical connector plugs 10. That is, end portions of some of the ferrules 11 protrude further than end portions of the remaining ferrules 11 by a protrusion amount D. A value of the protrusion amount D is, for example, 0.1 mm or more and 0.5 mm or less, but it can be appropriately changed.

In the embodiment, the ferrules 11 located on both end sides in the direction D2 protrude further to the adapter side than the ferrules 11 located on a center side in the direction D2. As a specific example, eight ferrules 11 on both end sides in the direction D2 protrude further to the adapter side than the four ferrules 11 on the center side in the direction D2. The number and arrangement of the optical connector plugs 10 with the ferrules 11 protruding to the adapter side can be appropriately changed.

As described above, since the ferrules 11 of some of the optical connector plugs 10 protrude further than the ferrules 11 of the remaining optical connector plugs 10, a difference is provided in a mounting position of the optical connector plugs 10 in the direction D1. Therefore, it is possible to shift a timing of insertion resistance occurring in each of the optical connector plugs 10 at the time of insertion into the adapter, thereby avoiding concentration of the insertion resistance.

The holder 15 collectively holds the plurality of optical connector plugs 10 arranged in the direction D3. The holders 15 are arranged in the direction D2, and each of the holders 15 is fixed to the support member 16. For example, six holders 15 are provided, and each of the holders 15 holds two optical connector plugs 10.

The support member 16 may have a pressing portion 18 which presses the four optical connector plugs 10 located on the center side in the direction D2 toward the adapter side. The support member 16 is, for example, in the form of a plate. The support member 16 has a main surface 16a which fixes each of the holders 15, and the main surface 16a is directed to one side in the direction D3. For example, the four holders 15 located on both end sides in the direction D2 protrude further to the adapter side than the remaining two holders 15.

The support member 16 includes a grip portion 17 located behind the optical connector plug 10. The grip portion 17 is formed by an opening passing through the support member 16 and has a shape which is easily gripped by inserting a finger into the opening and griping the grip portion 17. The opening forming the grip portion 17 is, for example, an elliptical shape extending in the direction D2.

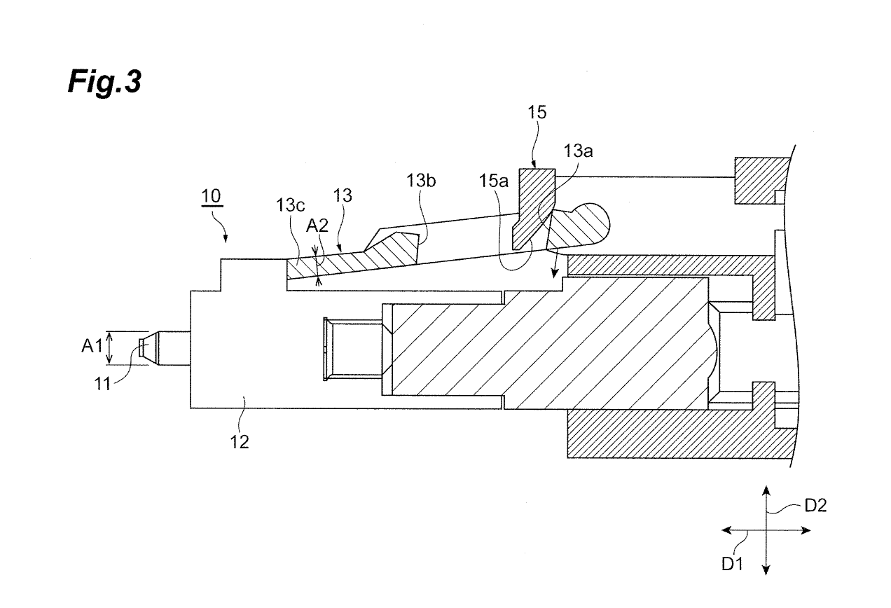

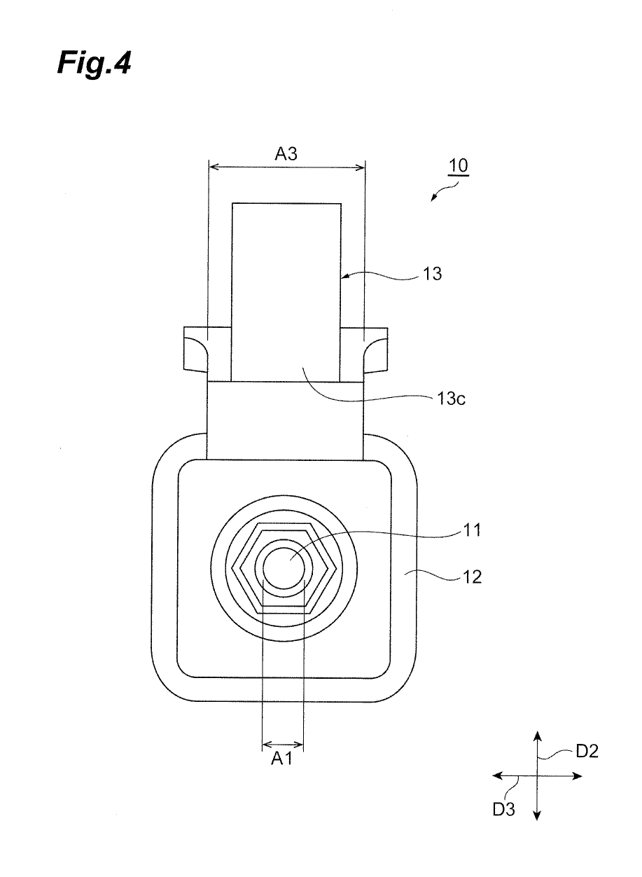

FIG. 3 is an enlarged cross-sectional view of the optical connector plug 10. FIG. 4 is a front view of the optical connector plug 10 when seen from the front side. As illustrated in FIGS. 3 and 4, the latch mechanism 13 has a plate shape which extends in the direction D1 and obliquely upward. The latch mechanism 13 is formed of, for example, a resin material. The latch mechanism 13 includes a contact portion 13a which is in contact with the holder 15, an engagement portion 13b which engages with the adapter, and a fixed portion 13c which is fixed to the front housing 12. The contact portion 13a, the engagement portion 13b, and the fixed portion 13c are arranged in this order from the rear to the front.

A so-called push-pull mechanism is provided in the optical connector plug 10 and the holder 15. The holder 15 is pulled out by this push-pull mechanism in the direction D1, and thus the optical connector plug 10 can be removed from the adapter. For example, the optical connector plug 10 is slidable with respect to the holder 15 in the direction D1.

The latch mechanism 13 bends in the direction D2 with the fixed portion 13c as a base point. Therefore, the contact portion 13a can move in the direction D2. An inclined surface 15a which is inclined with respect to the direction D1 and the direction D2 is formed in a portion which comes into contact with the contact portion 13a of the holder 15. When the holder 15 slides backward with the pulling-out of the holder 15, the contact portion 13a is pushed down by the inclined surface 15a. As a result, as the entire latch mechanism 13 is pushed down, the engagement between the engagement portion 13b and the adapter is released. Then, it becomes possible to pull out the optical connector plug 10 from the adapter.

Both a thickness A2 of the latch mechanism 13 and a width A3 of the latch mechanism 13 are smaller than values defined by the standard of LC connectors. For example, the thickness A2 is 0.4 mm or more and less than 0.6 mm, and the width A3 is 2.0 mm or more and less than 3.2 mm. Further, a diameter A1 of the ferrule 11 is smaller than that defined by the standard of LC connectors, and is, for example, 1.246 mm or more and 1.248 mm or less.

Next, an operation and an effect obtained from the optical connector 1 according to the embodiment will be described.

The optical connector 1 includes the optical connector plugs 10 which are connected to the plurality of adapters collectively in the direction D1. Each of the optical connector plugs 10 has the tubular ferrule 11 which holds an optical fiber, and the diameter A1 of the ferrule 11 is smaller than that of a ferrule defined by the international standard (the standard of LC connectors). Therefore, it is easy to insert the ferrules 11 of the plurality of optical connector plugs 10. Therefore, the optical connector plugs 10 can be smoothly inserted.

Further, each of the optical connector plugs 10 has the latch mechanism 13 which engages the optical connector plug 10 with the adapter, and the thickness A2 and the width A3 of the latch mechanism 13 are smaller than a thickness and a width of a latch mechanism defined by the international standard. As described above, since the thickness A2 and the width A3 are smaller than the values defined by the international standard, the latch mechanism 13 can be easily bent. Therefore, since a force required at the time of engagement of the latch mechanism 13 can be reduced, the optical connector plugs 10 can be smoothly inserted.

### Second Embodiment

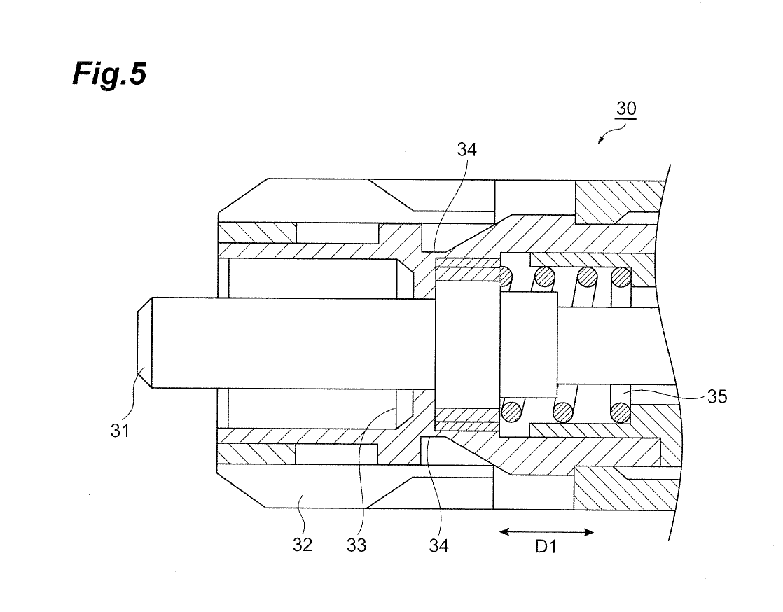

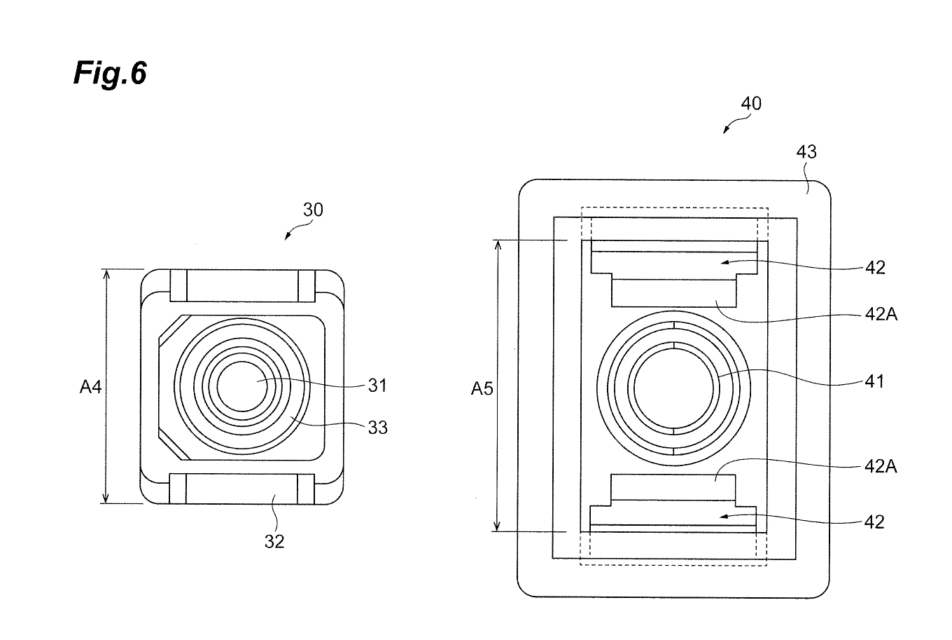

Next, an optical connector plug 30 and an adapter 40 according to a second embodiment will be described with reference to FIGS. 5 and 6. In the following description, redundant descriptions are appropriately omitted. The optical connector plug 30 and the adapter 40 conform to the standard of SC connectors. The optical connector plug 30 includes a ferrule 31 which holds an optical fiber, a front housing 32 which accommodates the ferrule 31, and a spring 35 which biases the ferrule 31. A load of the spring 35 is smaller than that of a spring defined by the standard of SC connectors and is, for example, 6.0 N or more and less than 9.8 N.

The ferrule 31 has a tubular shape. The front housing 32 has an accommodation recess 33 which accommodates the ferrule 31. A shape of the front housing 32 when seen from the front side is a quadrangular shape. An engagement recess 34 which engages with the adapter 40 is formed on a pair of surfaces of the front housing 32. A distance A4 between the pair of surfaces of the front housing 32 in which the engagement recesses 34 are provided is smaller than that defined by the standard of SC connectors. The distance A4 is, for example, 8.60 mm or more and less than 8.89 mm.

The adapter 40 includes a sleeve 41 into which the ferrule 31 is inserted, a latch mechanism 42 which engages with the optical connector plug 30, and a housing 43 which accommodates the sleeve 41 and the latch mechanism 42. A pair of latch mechanisms 42 are provided at positions corresponding to the engagement recesses 34 of the optical connector plug 30. The latch mechanism 42 has an engagement protrusion 42A which engages with the engagement recess 34. A distance A5 between the pair of latch mechanisms 42 is smaller than that defined by the standard of SC connectors, and is, for example, 8.60 mm or more and less than 8.89 mm.

As described above, in the second embodiment, the optical connector plug 30 includes the ferrule 31 which holds the optical fiber and the spring 35 which biases the ferrule 31 in the direction D1, and the load of the spring 35 is smaller than that of a spring defined by the international standard of the optical connector (the standard of SC connectors). That is, the load of the spring 35 which biases the ferrule 31 in the direction D1 is smaller than the load defined by the international standard. Therefore, since the resistance due to the load of the spring 35 applied when connecting can be reduced, the optical connector plug 30 can be smoothly inserted.

Although the optical connector plug 10 of the LC connector of the first embodiment also includes the spring which biases the ferrule 11, the load of the spring of the LC connector may be small as described above. For example, the load of the spring of the optical connector plug 10 is smaller than that of a spring defined by the standard of LC connectors and is, for example, 3.0 N or more and less than 4.9 N.

Further, a distance A4 between the pair of surfaces of the front housing 32 in which the engagement recesses 34 are provided is smaller than that defined by the standard of SC connectors. Therefore, since a deformation amount of the latch mechanism 42 of the adapter 40 can be reduced, the insertion resistance of the optical connector plug 30 with respect to the adapter 40 can be reduced. Further, a distance A5 between the pair of latch mechanisms 42 is smaller than that defined by the standard of SC connectors. Therefore, since the latch mechanism 42 becomes thin and the latch mechanism 42 is easily deformed, the insertion resistance of the optical connector plug 30 with respect to the adapter 40 can be reduced.

### Third Embodiment

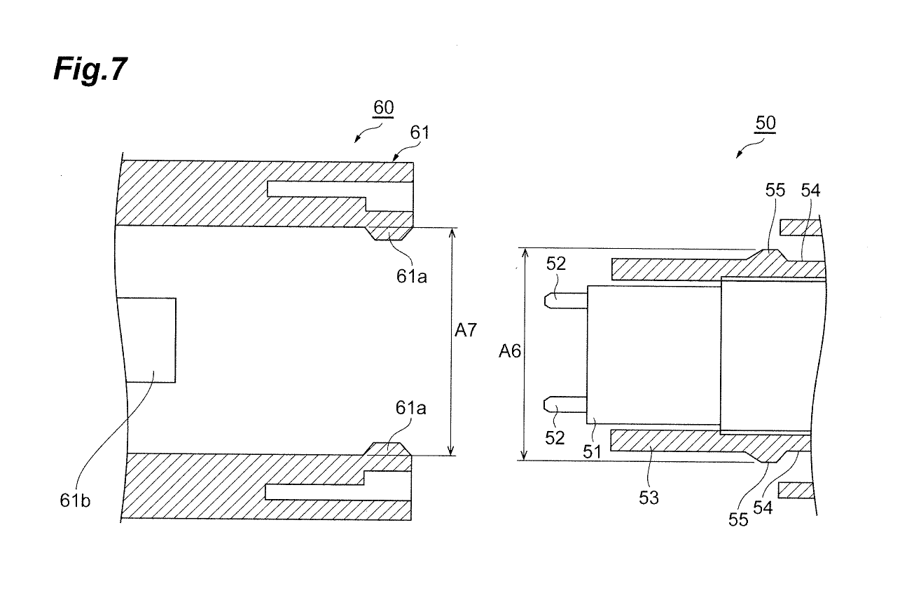

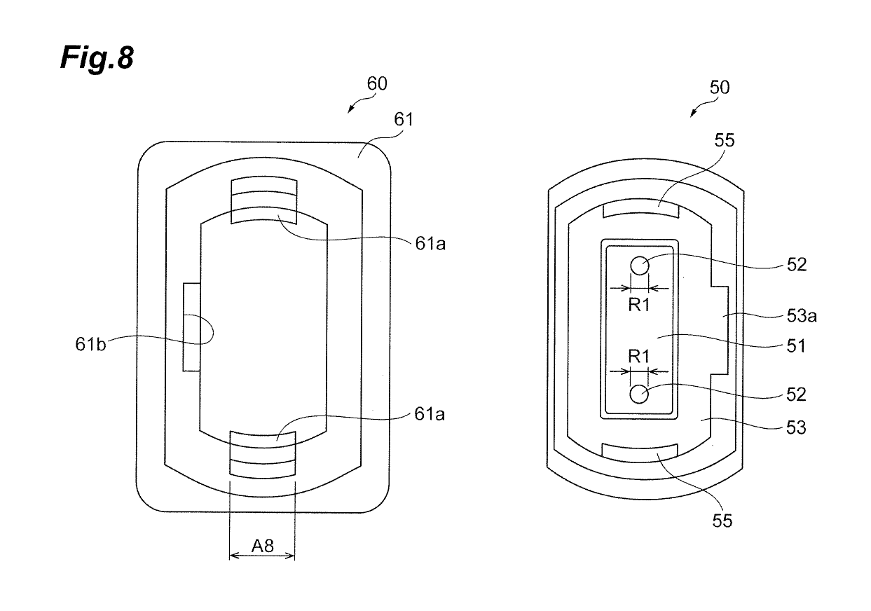

Next, an optical connector plug 50 and an adapter 60 according to a third embodiment will be described with reference to FIGS. 7 and 8. The optical connector plug 50 and the adapter 60 conform to the standard of MPO connectors. The optical connector plug 50 includes a ferrule 51 which holds an optical fiber, a guide pin 52 which positions the optical connector plug 50 and the adapter 60, and a front housing 53 which accommodates the ferrule 51.

The ferrule 51 has a rectangular shape. An engagement recess 54 and an engagement protrusion 55 which engage with the adapter 60 are provided on a surface of the front housing 53. The engagement recess 54 is provided on a rear side of the engagement protrusion 55. A shape of the front housing 53 when seen from the front side is a quadrangular shape which is curved so that a short side expands, and the engagement recess 54 and the engagement protrusion 55 are provided on a pair of surfaces of the front housing 53.

A distance A6 between the pair of engagement protrusions 55 is smaller than that defined by the standard of MPO connectors and is, for example, 9.29 mm or more and less than 9.49 mm. Further, a diameter R1 of the guide pin 52 is smaller than that defined by the standard of MPO connectors and is, for example, 0.697 mm or more and less than 0.699 mm.

The adapter 60 includes a rectangular tubular housing 61 which accommodates the optical connector plug 50. The housing 61 has a pair of engagement protrusions 61a which engage with the optical connector plug 50, and a groove 61b into which a key protrusion 53a of the front housing 53 is inserted. The engagement protrusions 61a are provided to correspond to the engagement recesses 54, and the pair of engagement protrusions 61a engage with the engagement recesses 54.

A distance A7 between roots of the pair of engagement protrusions 61a is larger than that defined by the standard of MPO connectors. The distance A7 is, for example, more than 9.0 mm and 9.6 mm or less. A width A8 of each of the engagement protrusions 61a is smaller than that defined by the standard of MPO connectors. The width A8 is 2.0 mm or more and less than 2.4 mm.

As described above, in the third embodiment, the optical connector plug 50 includes the ferrule 51 which holds the optical fiber and the guide pin 52 which positions the optical connector plug 50 and the adapter 60, and the thickness of the guide pin 52 is thinner than that of the guide pin defined by the international standard of the optical connector (the standard of MPO connectors). Therefore, since the thickness of the guide pin 52 inserted into the guide hole formed on the adapter 60 side is thinner than that defined by the international standard, the guide pin 52 can be smoothly inserted into the guide hole. Therefore, it is possible to smoothly insert the optical connector plug 50 into the adapter 60.

The distance A7 between the roots of the pair of engagement protrusions 61a is larger than that defined by the standard of MPO connectors. Accordingly, since the deformation amount of the engagement protrusion 61a of the adapter 60 can be reduced, the insertion resistance of the optical connector plug 50 to the adapter 60 can be reduced. The width A8 of each of the engagement protrusions 61a is smaller than that defined by the standard of MPO connectors. Therefore, since a deforming reaction force of the engagement protrusion 61a can be reduced, the insertion resistance of the optical connector plug 50 to the adapter 60 can be reduced.

### Fourth Embodiment

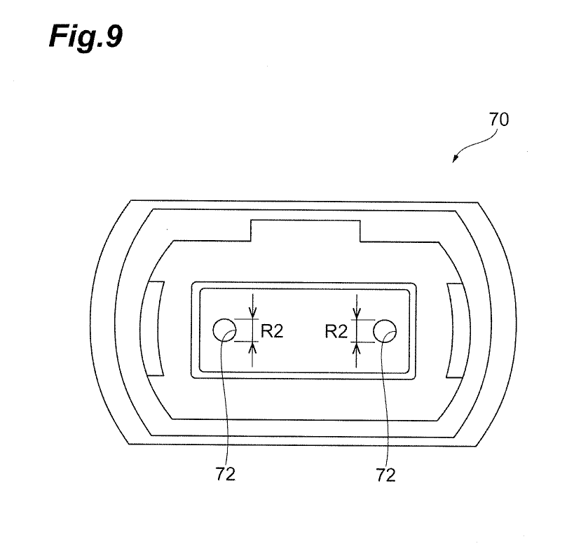

Next, an optical connector plug 70 according to a fourth embodiment will be described with reference to FIG. 9. The optical connector plug 70 is different from the third embodiment in that a guide hole 72 is provided instead of the guide pin 52 of the optical connector plug 50. A guide pin inserted into the guide hole 72 is provided on the adapter side. A diameter R2 of the guide hole 72 is larger than that defined by the standard of MPO connectors. The diameter R2 is, for example, greater than 0.701 mm and 0.703 mm or less.

In the optical connector plug 70 according to the fourth embodiment, the diameter R2 of the guide hole 72 is larger than that of a guide hole defined by the international standard of the optical connector (the standard of MPO connectors). That is, since the diameter R2 of the guide hole 72 the guide pin which is provided on the adapter side to be inserted is larger than that defined by the international standard, the guide pin is smoothly inserted into the guide hole 72. Therefore, it is possible to smoothly insert the optical connector plug 70 into the adapter.

Although embodiments of the present disclosure have been described above, the present disclosure is not limited to the embodiments described above, and various modifications can be made. For example, the shape, size, material, number, and arrangement form of each portion of the optical connector plug are not limited to the above-described embodiments and can be appropriately changed.

Further, in the above embodiment, the optical connector 1 in which the ferrules 11 of some of the optical connector plugs 10 protrude further to the adapter side than the ferrules 11 of the remaining optical connector plugs 10 has been described. However, it may be an optical connector in which the ferrules of some of the optical connector plugs do not protrude to the adapter side.

Further, in the above embodiment, the optical connector plug 10 having the latch mechanism 13 in which the thickness A2 and the width A3 are smaller than the thickness and the width of the international standard has been described. However, it may be provided with an optical connector plug of which only one of the thickness and the width is smaller than one of the thickness and width of the international standard. Further, the shape, size, material, number, and arrangement form of each portion of the optical connector are not limited to the above-described embodiment and can be appropriately changed.

What is claimed is:

1. An optical connector which comprises a plurality of optical connector plugs collectively connected to a plurality of adapters in a connection direction,
wherein each of the optical connector plugs comprises a tubular ferrule which holds an optical fiber, and
a diameter of the ferrule is smaller than that of a ferrule defined by an international standard of the optical connector.

2. An optical connector which comprises a plurality of optical connector plugs collectively connected to a plurality of adapters in a connection direction,
wherein each of the optical connector plugs comprises a ferrule which holds an optical fiber and a spring which biases the ferrule in the connection direction, and
a load of the spring is smaller than that of a spring defined by an international standard of the optical connector.

3. An optical connector which comprises a plurality of optical connector plugs collectively connected to a plurality of adapters in a connection direction,
wherein each of the optical connector plugs comprises a plate-shaped latch mechanism which engages the optical connector plug with the adapter, and
at least one of a width and a thickness of the latch mechanism is smaller than at least one of a width and a thickness of a latch mechanism defined by an international standard of the optical connector.

4. An optical connector which comprises a plurality of optical connector plugs collectively connected to a plurality of adapters in a connection direction,
wherein each of the optical connector plugs comprises a ferrule which holds an optical fiber, and a guide pin which positions the optical connector plug and the adapter, and
a thickness of the guide pin is thinner than that of a guide pin defined by an international standard of the optical connector.

5. An optical connector which comprises a plurality of optical connector plugs collectively connected to a plurality of adapters in a connection direction,
wherein each of the optical connector plugs comprises a ferrule which holds an optical fiber,
the ferrule has a guide hole into which a guide pin which positions the optical connector plug and the adapter is inserted, and
a diameter of the guide hole is larger than that of a guide hole defined by an international standard of the optical connector.
